(19) United States
(12) Patent Application Publication
(10) Pub. No.: US 2013/0252682 A1
(43) Pub. Date: Sep. 26, 2013

(54) GAME APPARATUS, PROGRAM, AND GAME PROVIDING METHOD

(71) Applicant: Tomoharu Umekawa, Tokyo (JP)

(72) Inventor: Tomoharu Umekawa, Tokyo (JP)

(73) Assignee: KONAMI DIGITAL ENTERTAINMENT CO., LTD., Tokyo (JP)

(21) Appl. No.: 13/992,153

(22) PCT Filed: Apr. 6, 2012
(86) PCT No.: PCT/JP2012/059500

§ 371 Date: Jun. 6, 2013

(30) Foreign Application Priority Data
Jun. 21, 2011 (JP) 2011137241

(51) Int. Cl. A63F 13/00

(52) U.S. Cl. CPC A63F 13/00
USPC 463/1

(57) ABSTRACT

A game apparatus provides a game in which a plurality of target characters are selected from a plurality of possessed characters owned by a player and are applied to an event. A storage unit stores, for each character, the required value for selection required to select the character and the attack power of the character. A controller selects the plurality of target characters from the plurality of possessed characters such that the total attack power, which is the total of the attack power of the plurality of target characters, is maximum under the condition that the sum of the required values for selection of the plurality of target characters is equal to or smaller than a permissible value for selection given to the player.

### TECHNICAL FIELD

The present invention relates to technologies for allowing users to play a game with characters.

### BACKGROUND ART

Games have been conventionally proposed in which a player uses a character (a monster, for example) given to the player for an event such as a battle. For example, Non-Patent Document 1 discloses a technology in which a player selects a desired combination of characters from a plurality of characters owned by the player to do battle against a character of another player. For each character, a value required for selection (hereafter called a required value for selection) and an ability value, such as attack power or defense power, are specified. Each player can select desired characters such that the sum of the required values for selection of the characters is equal to or smaller than a permissible value for selection given to the player.

### PRIOR ART DOCUMENT(S)

### Non-Patent Document(s)

Non-Patent Document 1: Application Style Vol. 2, a social game information magazine, published by East Press Co. Ltd., Apr. 1, 2011, pp. 26-29 (written in Japanese)

### SUMMARY OF INVENTION

### Technical Problem

Since the ability value and the required value for selection of each character are not necessarily proportional, even if a predetermined number of characters are selected in descending order of the ability values within the permissible value for selection, the sum of the ability values of the plurality of characters selected by the player may not be the maximum among a plurality of combinations. It is assumed here, for example, that the permissible value for selection of the player is 100; two characters A each have an ability value of 60 and a required value for selection of 50, and one character B has an ability value of 100 and a required value for selection of 100. When only the ability value is taken into account, the character B is selected (sum of ability values: 100), whereas, when the two characters A are selected within the permissible value for selection, the sum of the ability values (120) is larger, which is advantageous in a battle event against another player. It is, however, very difficult for the player to understand the optimum combination among a large number of character candidates. Taking the situation described above into consideration, an object of the present invention is to reduce the burden on the player in selecting a preferred combination of characters from a plurality of characters.

### Solution to Problem

Means employed by the present invention to solve the above-described problem will be described below. To make it easier to understand the present invention, reference symbols in the drawings will be included below in parentheses for convenience, but it is not intended to limit the present invention to the embodiments shown in the drawings.

A game apparatus (14A, 14B) of the present invention provides a game in which, for each character, a required value for selection (R) required to select the character and an ability value (PA, PD) of the character are set, and a plurality of target characters are selected from a plurality of possessed characters owned by a player and are applied to an event. The game apparatus (14A, 14B) includes a selector (32) adapted to select the plurality of target characters from the plurality of possessed characters such that the total (TA, TD) of the ability values (PA, PD) of the plurality of target characters is maximum under the condition that the sum (Rsum) of the required values for selection (R) of the plurality of target characters is equal to or smaller than a permissible value for selection (LA, LD) given to the player.

In the present invention, it is preferable that the selector (32) include an ability value analyzing section (32, SB1) adapted to calculate, for each of the plurality of possessed characters, an ability value corresponding to a unit amount of the required value for selection (R) of the possessed character, as a unit ability value (UA, UD); an index calculation section (32, SB3) adapted to calculate, for each of the plurality of possessed characters, an ability index value (XA[n], XD[n]) corresponding to the sum of the ability value (PA, PD) of the possessed character and the ability value acquired when the minimum value (UA_min, UD_min) of the unit ability values (UA, UD) is assigned to the remaining value obtained by subtracting the required value for selection (R) of the possessed character from the permissible value for selection (LA, LD) given to the player; and a first selection processor (32, SB4, SB5) adapted to select possessed characters in descending order of the ability values indicated by the ability index values (XA[n], XD[n]) of the possessed characters, as target characters, under the condition that the sum (Rsum) of the required values for selection (R) of the plurality of target characters is equal to or smaller than the permissible value for selection (LA, LD) given to the player.

It is preferable that the first selection processor (32, SB4, SB5) be adapted to sequentially select possessed characters in descending order of the ability values indicated by the ability index values (XA[n], XD[n]), and to calculate the accumulated value of the required values for selection (R) of the selected possessed characters, and in which when the accumulated value has exceeded the permissible value for selection (LA, LD) of the player, the first selection processor is adapted to release the selection of the possessed character selected last and select the next possessed character in order.

In the present invention, it is preferable that the selector (32) further include a second selection processor (32, SA) adapted to select, when the sum (Rsum) of the required values for selection (R) of a predetermined number of possessed characters selected in descending order of the ability values (PA, PD) is equal to or smaller than the permissible value for selection (LA, LD), the predetermined number of possessed characters as target characters, in which the first selection processor (32, SB4, SB5) is adapted to select target characters according to the ability index values (XA[n], XD[n]) when the sum (Rsum) of the required values for selection (R) of the predetermined number of possessed characters has exceeded the permissible value for selection (LA, LD).

In the present invention, it is preferable that the selector (32) be adapted to designate a specific character as a target character from the plurality of possessed characters and to select target characters other than the specific character from the plurality of possessed characters such that the sum (Rsum) of the required values for selection (R) of target characters that include the specific character is equal to or smaller than the permissible value for selection (LA, LD) of the player. The specific character is a possessed character selected by the player, for example.

In the present invention, it is preferable that the ability value (PA, PD) include a first ability value (PA) and a second ability value (PD); and the selector (32) is adapted to select a plurality of target characters to be applied to a first event (for example, a battle event in which the player is on the attack side) such that the total (TA) of the first ability values (PA) is maximum under the condition that the sum (Rsum) of the required values for selection (R) of the plurality of target characters is equal to or smaller than a first permissible value for selection (LA) of the player, and to select a plurality of target characters to be applied to a second event (for example, a battle event in which the player is on the defense side) such that the total (TD) of the second ability values (PD) is maximum under the condition that the sum (Rsum) of the required values for selection (R) of the plurality of target characters is equal to or smaller than a second permissible value for selection (LD) of the player.

The present invention can also be applied to a program (PGM) for causing a computer to function as the game apparatus (14A, 14B) described above. A program (PGM) of the present invention causes, in order to provide a game in which, for each character, a required value for selection (R) required to select the character and an ability value (PA, PD) of the character are set, and a plurality of target characters are selected from a plurality of possessed characters owned by a player and are applied to an event, a computer to function as a selector (32) adapted to select the plurality of target characters from the plurality of possessed characters such that the total (TA, TD) of the ability values (PA, PD) of the plurality of target characters is maximum under the condition that the sum (Rsum) of the required values for selection (R) of the plurality of target characters is equal to or smaller than a permissible value for selection (LA, LD) given to the player. The program (PGM) of the present invention is stored in a computer-readable recording medium, is provided in that form, and is installed in a computer. Alternatively, the program of the present invention is distributed through a communication network and is installed in a computer.

The present invention can also be applied to a game providing method. A game providing method of the present invention provides a game in which, for each character, a required value for selection (R) required to select the character and an ability value (PA, PD) of the character are set, and a plurality of target characters are selected from a plurality of possessed characters owned by a player and are applied to an event. The game providing method includes selecting the plurality of target characters from the plurality of possessed characters such that the total (TA, TD) of the ability values (PA, PD) of the plurality of target characters is maximum under the condition that the sum (Rsum) of the required values for selection (R) of the plurality of target characters is equal to or smaller than a permissible value for selection (LA, LD) given to the player, in a game apparatus (14A, 14B).

### BRIEF DESCRIPTION OF THE DRAWINGS

FIG. 1 is a block diagram of a game system according to a first embodiment of the present invention.

FIG. 2 is a schematic view of player information and character information.

FIG. 3 is a flowchart of a deck organizing process.

FIG. 4 is a schematic view of unit data in a second embodiment.

FIG. 5 is a flowchart of a deck organizing process in the second embodiment.

FIG. 6 is a block diagram of a game apparatus according to a third embodiment.

### DESCRIPTION OF EMBODIMENTS

### First Embodiment

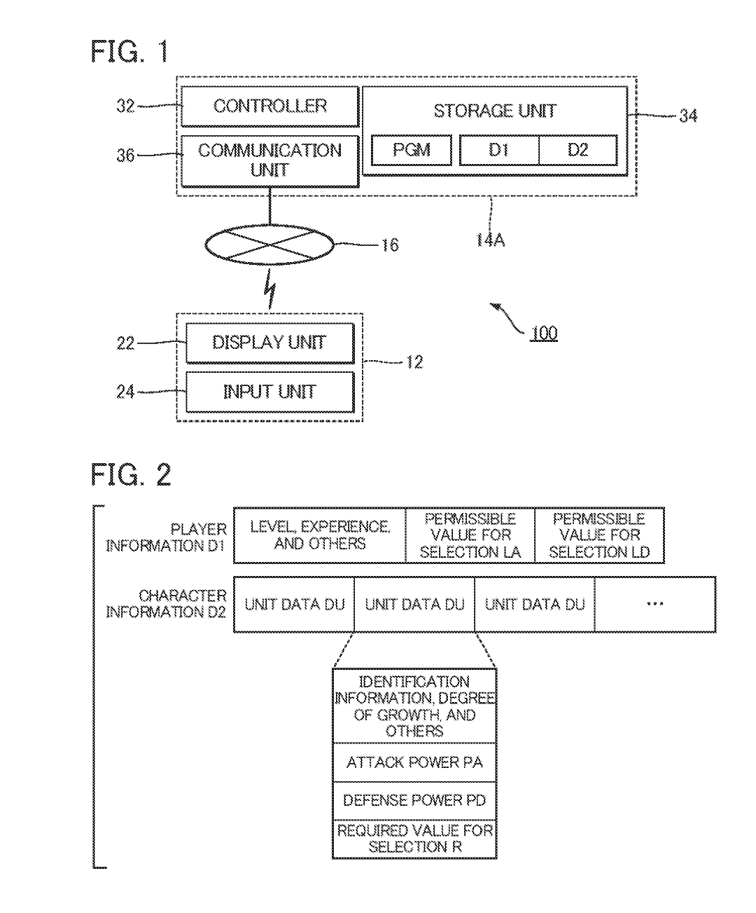

FIG. 1 is a block diagram of a game system 100 according to a first embodiment of the present invention. The game system 100 of the first embodiment includes a terminal apparatus 12 and a game apparatus 14A, communicating with each other through a communication network 16 such as the Internet. The player who owns the terminal apparatus 12 plays a game. FIG. 1 shows just one terminal apparatus 12 for convenience, but actually, a plurality of terminal apparatuses 12 communicate with the game apparatus 14A through the communication network 16.

The terminal apparatus 12 is a communication terminal, such as a portable telephone, a personal digital assistant (PDA), or a personal computer, and includes a display unit 22 and an input unit 24. The display unit 22 (such as a liquid crystal display panel) displays various types of images, such as a game screen. The input unit 24 is used by the player to input an instruction to the terminal apparatus 12, and includes a plurality of manipulanda operated by the user, for example. A touch sensitive panel integrated with the display unit 22 for receiving user manipulation, or a microphone used by the user to input sound to give an instruction to the terminal apparatus 12 can be employed as the input unit 24.

The game apparatus 14A is a web server for providing a browser-based game for the player owning the terminal apparatus 12. A browser-based game can be played by executing a web browser in the terminal apparatus 12 (the user does not need to download special game software into the terminal apparatus 12). More specifically, the game apparatus 14A executes various processes when the terminal apparatus 12 sends a request according to an instruction given by the player via the input unit 24 and causes the display unit 22 of the terminal apparatus 12 to display a web page (game screen) indicating the results of the processes. In the first embodiment, the game apparatus 14A provides the terminal apparatus 12 with a social game of a role-playing game (RPG) type in which the player uses a plurality of characters (hereafter called “possessed characters”), such as monsters, given to the player in the game to execute events, such as battles with another player. A plurality of players can give and take the characters given to them.

A deck organized for each player is used in a battle event in the game. The deck is a set of one or more characters (hereafter called target characters) up to M (M is a natural number) characters selected from a plurality of possessed characters given to the player. In a battle event, an attack deck of a player who is on the attack side and a defense deck of another player who is on the defense side are organized, and the battle is made between the attack deck and the defense deck. Each player can be on either the attack side or the defense side in a battle event. One or more target characters constituting the attack deck used when one player is on the attack side and one or more target characters constituting the defense deck used when that player is on the defense side are selected individually and can be identical.

As shown in FIG. 1, the game apparatus 14A includes a controller 32, a storage unit 34, and a communication unit 36. The communication unit 36 communicates with the terminal apparatus 12 through the communication network 16. The storage unit 34 stores various types of data used by the controller 32 and a program (game program) PGM executed by the controller 32. As the storage unit 34, a known recording medium, such as a semiconductor recording medium or a magnetic recording medium, or a combination of a plurality of types of recording media can be used. The storage unit 34 may be installed in an external apparatus (such as a server) separated from the game apparatus 14A, and the game apparatus 14A may acquire information from the storage unit 34 through the communication network 16. In other words, the storage unit 34 is not essential for the game apparatus 14A. The storage unit 34 (one virtual storage unit) may be realized with a plurality of units configured separately from each other.

The storage unit 34 stores, for each player, player information D1 and character information D2, corresponding to the game progress of the player. FIG. 2 is a schematic view of the player information D1 and the character information D2. The player information D1 specifies parameters of the player used in the game. Specifically, as shown in FIG. 2, the player information D1 includes information, such as the level and experience of the player, the permissible value for selection LA for the attack deck, and the permissible value for selection LD for the defense deck. The permissible value for selection LA is a value (capacity) specifying a limit for selecting the target characters for the attack deck from the possessed characters, and the permissible value for selection LD is a value (capacity) specifying a limit for selecting the target characters for the defense deck from the possessed characters. When the level of the player increases due to the achievement of various types of events in the game, the permissible value for selection LA and the permissible value for selection LD are increased individually. Elements related to attacking in battle events are denoted with A (attack), and elements related to defending in battle events are denoted with D (defense), as in the notation of the permissible value for selection LA and the permissible value for selection LD.

The character information D2 relates to the possessed characters given to each player. As shown in FIG. 2, the character information D2 includes a unit data DU for each of the possessed characters of the player. The unit data DU of each possessed character includes information, such as the identification information and the degrees of advancement (level, experience, and others), attack power PA, defense power PD, and required value for selection R. The attack power PA is an index value of the attack ability of a possessed character, and the defense power is an index value of the defense ability of the possessed character. When the degree of advancement (level) of a possessed character increases due to the achievement of various types of events, the attack power PA and the defense power PD are increased.

The required value for selection R means the amounts consumed from the permissible value for selection LA and the permissible value for selection LD, required for selecting a possessed character as a target character. One or more target characters constituting the attack deck are selected from the plurality of possessed characters of the player such that the sum Rsum of the required values for selection R of the target characters is equal to or smaller than the permissible value for selection LA of the attack deck. In other words, the permissible value for selection LA means the upper limit of the sum Rsum of the required values for selection R of the target characters constituting the attack deck.

In the same way, the target characters constituting the defense deck are selected from the plurality of possessed characters of the player such that the sum Rsum of the required values for selection R of the target characters is equal to or smaller than the permissible value for selection LD of the defense deck. In other words, the permissible value for selection LD means the upper limit of the sum Rsum of the required values for selection R of the target characters constituting the defense deck.

As will be understood from the above description, the larger the permissible value for selection LA of the player, the higher the possibility of being able to select a large number of possessed characters having large required values for selection R as the target characters of the attack deck; and the larger the permissible value for selection LD of the player, the higher the possibility of being able to select a large number of possessed characters having large required values for selection R as the target characters of the defense deck.

The controller 32 shown in FIG. 1 executes the process corresponding to an instruction given by the player via the input unit 24 and causes the display unit 22 of the terminal apparatus 12 to display a web page showing the result of the process. When the player gives an instruction to start a battle event, for example, the controller 32 compares the sum (hereafter called the total attack power) TA of the attack power PA of the one or more target characters constituting the attack deck of the player on the attack side (the player who gave an instruction to start the battle event, for example) with the sum (hereafter called the total defense power) TD of the defense power PD of the one or more target characters constituting the defense deck of the player on the defense side (the player designated as the opponent in the battle by the player on the attack side, for example). When the total attack power TA exceeds the total defense power TD, the controller 32 determines that the player on the attack side wins; and if the total attack power TA is lower than the total defense power TD, the controller 32 determines that the player on the defense side wins. Then, the controller 32 causes the display unit 22 of the terminal apparatus 12 of each player to display a web page showing the determination result.

The controller 32 of the first embodiment also executes deck organizing processes of organizing the attack deck of the player on the attack side by selecting target characters from the plurality of possessed characters of the player and of organizing the defense deck of the player on the defense side by selecting target characters from the plurality of possessed characters of the player. The deck organizing process of organizing the attack deck selects one or more target characters constituting the attack deck, up to M target characters, from the plurality of possessed characters of the player on the attack side such that the total attack power TA of the attack deck is maximum under the condition that the sum Rsum of the required values for selection R of the target characters is equal to or smaller than the permissible value for selection LA of the player on the attack side. In the same way, the deck organizing process of organizing the defense deck selects one or more target characters constituting the defense deck, up to M target characters, from the plurality of possessed characters of the player on the defense side such that the total defense power TD of the defense deck is maximum under the condition that the sum Rsum of the required values for selection R of the target characters is equal to or smaller than the permissible value for selection LD of the player on the defense side. In other words, the controller 32 functions as an element (selector) for selecting target characters from a plurality of possessed characters.

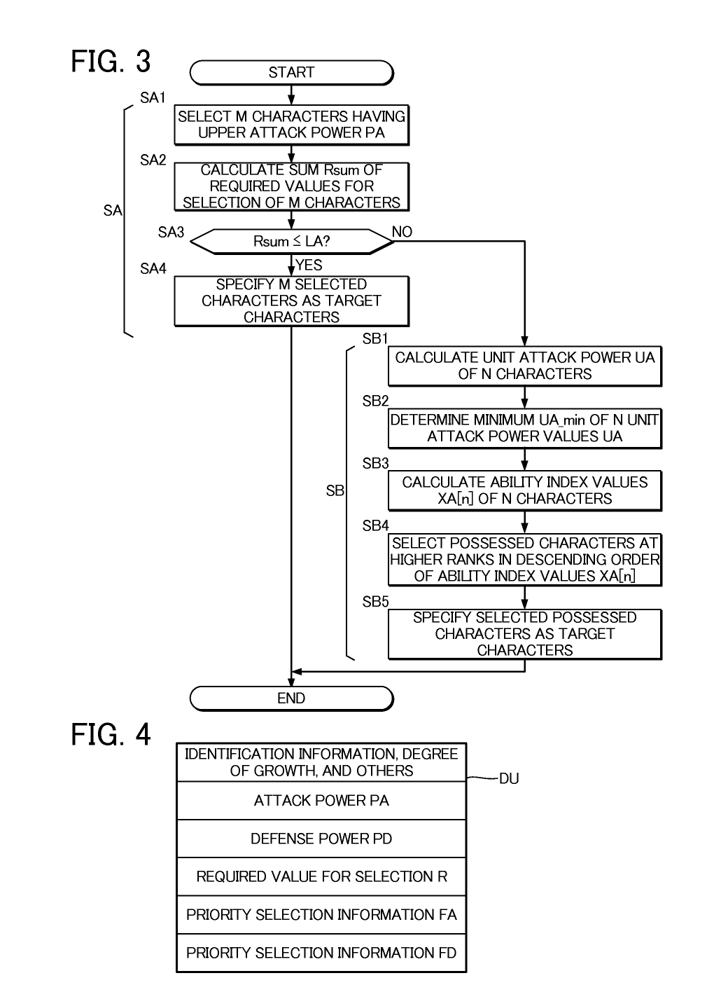

FIG. 3 is a flowchart of the deck organizing process of organizing the attack deck from N (N is a natural number) possessed characters of the player. The process of FIG. 3 is executed when a battle event in which the player serves as the attack side starts or when the player gives an instruction to organize the attack deck. The deck organizing process of FIG. 3 is divided into a selection process SA and a selection process SB. When the selection process SA starts, the controller 32 selects M characters at higher ranks in descending order of the attack power PA from N possessed characters of the player (step SA1). Then, the controller 32 calculates the sum Rsum of the required values for selection R of the M characters selected in step SA1 (step SA2).

The controller 32 determines whether the sum Rsum calculated in step SA2 is equal to or smaller than the permissible value for selection LA of the player (step SA3). If the result of determination in step SA3 is affirmative (Rsum≦LA), the controller 32 specifies the M characters selected in step SA1 as the target characters of the attack deck (step SA4), and finishes the deck organizing process without executing the selection process SB. As will be understood from the above description, when the sum Rsum of the required values for selection R of M characters at higher ranks in descending order of the attack power PA among N possessed characters is equal to or smaller than the permissible value for selection LA of the player, the controller 32 functions as an element (second selection processor) for selecting the M possessed characters having higher attack power PA as the target characters.

If the result of determination in step SA3 is negative (Rsum>LA), the controller 32 starts the selection process SB. The controller 32 first calculates, as the unit attack power UA, the attack power PA of each of the N possessed characters of the player, corresponding to the unit amount of the required value for selection R (that is, the attack power obtained when the unit amount of the permissible value for selection LA is consumed) (step SB1). The unit attack power UA is specifically the ratio of the attack power PA to the required value for selection R (UA=PA/R), and means the efficiency at which the selection of a possessed character (the consumption of the permissible value for selection LA) contributes to the increase of the total attack power TA of the attack deck. As understood from the above description, the controller 32 functions as an element (ability-value analyzing section) for calculating the unit attack power UA of each of the N possessed characters.

The controller 32 determines the minimum value UA_min (hereafter called the lowest efficiency) of the unit attack power values UA calculated for the N possessed characters in step SB1 (step SB2). The lowest efficiency UA_min is the unit attack power UA of the possessed character that contributes to the increase of the total attack power TA of the attack deck with the lowest efficiency.

The controller 32 calculates the ability index values XA[n] (XA[1] to XA[N]) of the N possessed characters (step SB3). The ability index value XA[n] of the n-th possessed character corresponds to the total attack power TA of the attack deck obtained when it is assumed that the whole of the remaining amount of the permissible value for selection LA left when that possessed character was selected is consumed at the lowest efficiency UA_min, and is calculated by the following expression (1), for example.

XA[n]=(LA−R[n])×UA_min+PA[n] (1)

Here, PA[n] indicates the attack power PA of the n-th possessed character in the N possessed characters; (LA−R[n]) indicates the remaining amount of the permissible value for selection LA obtained when it is assumed that the n-th possessed character (with the required value for selection R[n]) was selected; and the product {(LA−R[n])×UA_min} of the remaining amount (LA−R[n]) and the lowest efficiency UA_min is the attack power obtained when it is assumed that the whole of the remaining amount (LA−R[n]) was consumed by selecting a character having the lowest efficiency UA_min. As described above, the controller 32 functions as an element (index calculation section) for calculating the ability index value XA[n] for each of the N possessed characters.

The controller 32 selects possessed characters at higher ranks in descending order of the attack power (total attack power TA) indicated by the N ability index values XA[1] to XA[N] calculated in step SB3 such that the sum Rsum of the required values for selection R of the selected possessed characters is equal to or smaller than the permissible value for selection LA of the player (step SB4). More specifically, the controller 32 sequentially selects possessed characters in descending order of the ability index values starting from the possessed character having the maximum ability index value XA[n]; accumulates the required value for selection every time the selection is made; and when the accumulation of the required values for selection R exceeds the permissible value for selection LA, releases the selection of the possessed character selected last and selects the next possessed character in order. This process is repeated. When the number of selected possessed characters reaches M or when the process is completed for all of the N possessed characters, the controller 32 specifies the plurality of possessed characters selected in step SB4 as the target characters of the attack deck (step SB5). In other words, the controller 32 functions as an element (first selection processor) for selecting possessed characters in descending order of the attack power, indicated by the ability index values XA[n], as the target characters such that the sum Rsum of the required values for selection R of the target characters is equal to or smaller than the permissible value for selection LA of the player. This describes the deck organizing process of the attack deck.

The deck organizing process of the defense deck is executed using a procedure similar to that shown in FIG. 3. Specifically, in the selection process SA (SA1 to SA4) of the deck organizing process of the defense deck, if the sum Rsum of the required values for selection R of M possessed characters having upper defense power PD is equal to or smaller than the permissible value for selection LD of the player, the controller 32 selects the M possessed characters having upper defense power PD as the target characters of the defense deck.

If the sum Rsum of the required values for selection R of the M possessed characters having upper defense power PD exceeds the permissible value for selection LD (No in step SA3), the controller 32 executes the selection process SB of the deck organizing process of the defense deck. Specifically, the controller 32 calculates the unit defense power UD (UD=PD/R) of each of the N possessed characters (step SB1) and calculates ability index values XD[1] to XD[N] based on the lowest efficiency UD_min, which is the minimum unit defense power UD (steps SB2 and SB3). Then, the controller 32 selects possessed characters at higher ranks in descending order of the defense power, indicated by the ability index values XD[n], such that the sum Rsum of the required values for selection R is equal to or smaller than the permissible value for selection LD (step SB4), and specifies the possessed characters selected in step SB4 as the target characters of the defense deck (step SB5).

As described above, in the first embodiment, the target characters of the attack deck are selected from the N possessed characters such that the total attack power TA, which is the sum of the attack power PA of the target characters, is maximum under the condition that the sum Rsum of the required values for selection R of the target characters is equal to or smaller than the permissible value for selection LA of the player. The target characters of the defense deck are also selected using the similar procedure. Therefore, according to the first embodiment, it is possible to reduce the burden on the player in selecting an appropriate combination of characters from the N possessed characters.

In the first embodiment, any of the possessed characters is selected; the ability index value XA[n], which corresponds to the total attack power TA of the attack deck obtained when it is assumed that the whole of the remaining amount (LA−R[n]) of the permissible value for selection LA is consumed at the lowest efficiency UA_min after one possessed character is selected, is calculated for each of the possessed characters; and possessed characters are selected in descending order of the ability index values XA[n] as the target characters of the attack deck. Therefore, an advantage is provided in that a combination of possessed characters having high efficiency in contributing to the increase of the total attack power TA of the attack deck with respect to the consumption of the permissible value for selection LA can be selected appropriately. The attack deck has been described above, but the same advantage is also achieved for the defense deck.

In the first embodiment, possessed characters are sequentially selected in descending order of the ability index values XA[n]; the required values for selection R of the selected possessed characters are accumulated; and when the accumulation of the required values for selection R exceeds the permissible value for selection LA, the selection of the possessed character selected last is released and the next possessed character in order is selected. Therefore, an advantage is provided in that one or more target characters are selected to form the attack deck such that the sum Rsum of the required values for selection R of the target characters is sufficiently close to the permissible value for selection LA, compared with an example case in which a predetermined number of possessed characters are selected simply in descending order of the ability index values XA[n]. The attack deck has been described above, but the same advantage is also achieved for the defense deck.

In the first embodiment, one or more target characters are selected to form the attack deck according to the permissible value for selection LA of the player and the attack power PA of each of the possessed characters, and one or more target characters are selected to form the defense deck according to the permissible value for selection LD of the player and the defense power PD of each of the possessed characters. In other words, a plurality of target characters used in a battle event in which the player serves as the attack side (first event) and a plurality of target characters used in a battle event in which the player serves as the defense side (second event) can be selected individually.

### Second Embodiment

A second embodiment of the present invention will be described below. Note that, for units in the following example embodiments having the same effects or functions as in the first embodiment, the reference symbols used in the above description will be used again, and detailed descriptions thereof will be omitted.

In the first embodiment, the controller 32 of the game apparatus 14A automatically selects all of the target characters constituting the attack deck or the defense deck. In the second embodiment, however, a specific character is included with priority in the attack deck or the defense deck among the plurality of possessed characters of the player.

The player can appropriately manipulate the input unit 24 of the terminal apparatus 12 to designate one or more characters (hereafter called specific characters) to be included in the deck with priority among the N possessed characters. The specific characters are designated individually for the attack deck and the defense deck.

As shown in FIG. 4, each unit data DU of the character information D2 stored in the storage unit 34 of the game apparatus 14A includes priority selection information F (FA and FD) in addition to the same information (such as attack power PA and defense power PD) as in the first embodiment. The priority selection information FA is information (flag, for example) indicating whether the possessed character has been designated as a specific character of the attack deck (priority state or non-priority state), and the priority selection information FD is information indicating whether the possessed character has been designated as a specific character of the defense deck. When the designation of a specific character is received from the terminal apparatus 12, the controller 32 of the game apparatus 14A sets the priority selection information F (FA and FD) of the specific character designated by the player to the priority state.

In the second embodiment, special abilities are specified for some types of characters. The special abilities are enabled with a predetermined probability in an event such as a battle event and are used to achieve an advantage in the event. For example, special abilities advantageous in battle events where the player serves as the attack side include an ability to increase the total attack power TA of the attack deck of the player and an ability to decrease the total defense power TD of the defense deck of the opponent. Special abilities advantageous in battle events where the player serves as the defense side include an ability to increase the total defense power TD of the defense deck of the player and an ability to decrease the total attack power TA of the attack deck of the opponent. The controller 32 adjusts the total attack power TA of the attack deck and the total defense power TD of the defense deck according to the special abilities of the target characters participating in a battle event and determines the outcome of the battle event. Therefore, the player can achieve an advantage in a battle event by designating possessed characters having special abilities among the plurality of possessed characters as specific characters and including them in the attack deck or the defense deck with priority.

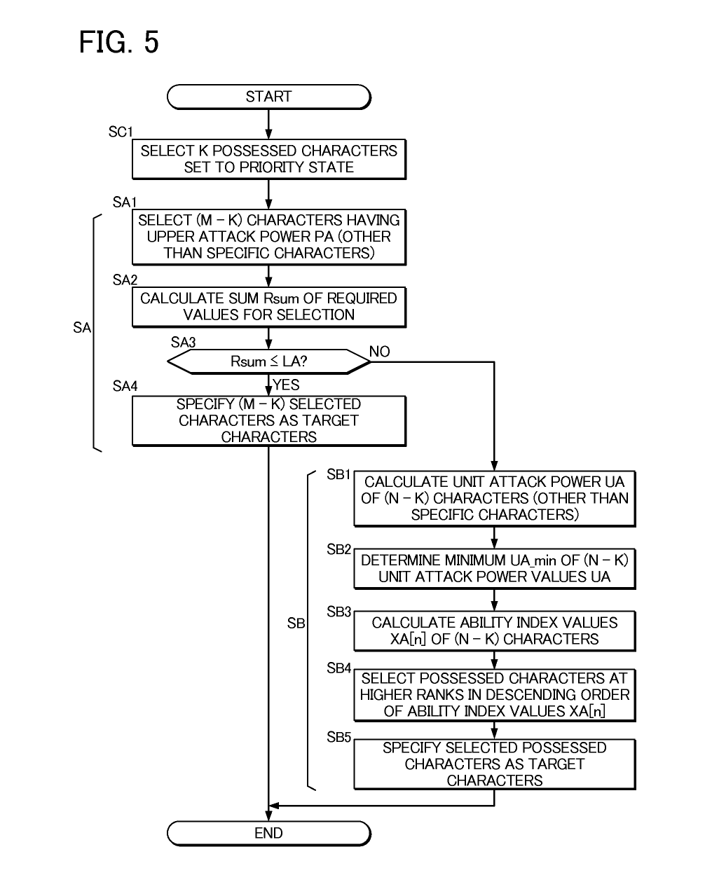

FIG. 5 is a flowchart of a deck organizing process in the second embodiment. A deck organizing process for an attack deck of the player on the attack side will be described below as an example. A deck organizing process for a defense deck of the player on the defense side is executed using a similar procedure.

As shown in FIG. 5, when the deck organizing process starts, the controller 32 selects K (K is a natural number equal to 1 or more) specific characters for which the priority selection information FA has been set to the priority state, as target characters (step SC1). Then, the controller 32 executes the same deck organizing process as in the first embodiment to select, as target characters, up to (M−K) possessed characters from (N−K) possessed characters, obtained by excluding the K specific characters selected in step SC1 from the N possessed characters of the player (in other words, to select possessed characters such that the number of target characters including the specific characters is equal to or smaller than M). In a selection process SA and a selection process SB, target characters are determined such that the sum Rsum of the required values for selection R of the K specific characters selected in step SC1 and the target characters selected in the selection process SA or the selection process SB is equal to or smaller than the permissible value for selection LA of the player.

More specifically, the controller 32 selects (M−K) possessed characters in descending order of the attack power PA from (N−K) possessed characters other than the specific characters (step SA1). Then, the controller 32 determines whether the sum Rsum of the required values for selection R of the M possessed characters in total formed of the (M−K) possessed characters and the K specific characters selected in step SC1 is equal to or smaller than the permissible value for selection LA of the player (steps SA2 and SA3). If the result of determination in step SA3 is affirmative, the controller 32 specifies the M possessed characters in total selected in step SC1 and step SA1 as the target characters of the attack deck (step SA4).

If the result of determination in step SA3 is negative, the controller 32 calculates the unit attack power UA of each of the (N−K) possessed characters other than the specific characters and determines the minimum unit attack power UA as the lowest efficiency UA_min (steps SB1 and SB2). The controller 32 calculates the ability index value XA[n] of each of the (N−K) possessed characters according to the lowest efficiency UA_min (step SB3). Then, the controller 32 sequentially selects possessed characters at higher ranks in descending order of the ability index values XA[n] from the (N−K) possessed characters other than the specific characters. The selection in step SB4 is executed such that the sum Rsum of the required values for selection R of the selected possessed characters is equal to or smaller than the permissible value for selection LA of the player and the number of the selected possessed characters is equal to or smaller than M. The controller 32 specifies the K specific characters selected in step SC1 and the possessed characters selected in step SB4 as the target characters of the attack deck (step SB5). The selection for the attack deck has been described above. The target characters constituting the defense deck are also selected using a similar method according to the defense power PD of each possessed character and the permissible value for selection LD of the player.

The second embodiment achieves the same advantages as the first embodiment. The second embodiment is advantageous in that K specific characters can be selected with priority as target characters irrespective of the ability values (PA and PD) and the required values for selection (LA and LD) of the characters. For example, in the example case described above, since the player designates the K specific characters, the attack deck or the defense deck can be organized so as to reflect the intent of the player. In addition, the player can achieve an advantage in a battle event by designating possessed characters having special abilities as specific characters and including them in the attack deck or the defense deck. The player can designate a favorite possessed character and can make the character actively participate in a battle event.

### Third Embodiment

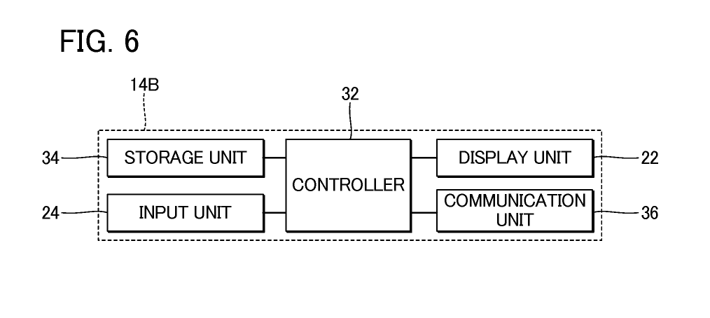

FIG. 6 is a block diagram of a game apparatus 14B according to a third embodiment. With the game apparatus 14B, the player (owner) can play the same game as in the first embodiment. A portable device, such as a portable telephone or a personal digital assistant, is suitable as the game apparatus 14B. As shown in FIG. 6, the game apparatus 14B includes a controller 32, a storage unit 34, a communication unit 36, a display unit 22, and an input unit 24. The communication unit 36 communicates with another game apparatus 14B. Communication conducted by the communication units 36 allows the players to participate in a battle event and other actions.

The storage unit 34 stores a program PGM, and player information D1 and character information D2 of each player in the same way as in the first embodiment. The controller 32 executes the program PGM to operate in the same manner as in the first embodiment. Specifically, the controller 32 executes the deck organizing process shown in FIG. 3 or FIG. 5 to organize the attack deck or the defense deck.

As will be understood from the above description, the game apparatus 14B of the third embodiment functions as a device that provides, by itself, the player with the game provided by the game apparatus 14A of the first embodiment. Therefore, the third embodiment achieves the same advantages as the first embodiment. The configuration of the second embodiment can be applied to the third embodiment.

Modifications

The embodiments described above can be modified in various ways. Specific example modifications will be described below. Two or more of the following modifications selected in a desired manner can be appropriately combined in a range in which no mutual contradiction occurs.

(1) The configuration in which the attack power PA, the defense power PD, and the required value for selection R of each possessed character are stored in the storage unit 34 for each player is not essential. For example, a configuration in which the identification information of each possessed character is stored in the storage unit 34 as character information D2 for each player, and a database having, for each character, the parameters (the attack power PA, the defense power PD, and the required value for selection R) of the character in association with the identification information is provided separately from the character information D2 can be used to identify the parameters of each possessed character of each player by referring to the database. As understood from the above description, in preferred embodiments of the present invention, it does not matter whether the required value for selection and the ability values (such as the attack power PA and the defense power PD) are specified for each character or whether each parameter of the character is stored for each player.

(2) In the embodiments described above, characters (such as monsters) are taken as example key figures in battle events. The contents and types of characters can be specified in a desired way in the present invention. For example, a configuration can be employed in which the controller 32 selects an appropriate combination of items, such as weapons and protectors, used by the player in various types of events, as characters.

(3) In the embodiments described above, when the sum Rsum of the required values for selection R is equal to or smaller than the permissible value for selection LA of the player, the selection process SA specifies the target characters; and when the sum Rsum exceeds the permissible value for selection LA, the selection process SB specifies the target characters. A configuration in which only the selection process SA is executed or a configuration in which only the selection process SB is executed can be employed. In the first to third embodiments, when the sum Rsum of the required values for selection R of M possessed characters having upper attack power PA is smaller than the permissible value for selection LA of the player, these M possessed characters are specified as the target characters, and the selection process SB is omitted. Therefore, it is advantageous in reducing the processing load on the controller 32, compared with a configuration in which the selection process SA in FIG. 3 is not executed and only the selection process SB is used to organize the attack deck. The same advantage is achieved also for the defense deck.

The process for selecting a plurality of target characters is not limited to the selection process SA or the selection process SB, described above. As understood from the foregoing description, the process executed by the controller 32 in the embodiments described above is just required to select a plurality of target characters from a plurality of possessed characters such that the total (TA or TD) of the ability values (PA or PD) of the plurality of target characters is maximum under the condition that the sum Rsum of the required values for selection R of the plurality of target characters is equal to or smaller than the permissible value for selection (LA or LD) given to the player. The specific processing does not matter.

(4) In the embodiments described above, the game apparatus 14A is a single device. However, the functions of the game apparatus 14A can be distributed to a plurality of apparatuses. For example, a configuration can be employed in which the controller 32 and the storage unit 34 are placed at different locations on the communication network 16 as separate devices. It is also possible that an authentication apparatus that executes authentication processing for the terminal apparatus 12 is placed between the terminal apparatus 12 and the game apparatus 14A and relays communications between the terminal apparatus 12 and the game apparatus 14A.

### REFERENCE NUMERALS

100: Game system
12: Terminal apparatus
14A, 14B: Game apparatus
16: Communication network
22: Display unit
24: Input unit
32: Controller
34: Storage unit
36: Communication unit

1. A game apparatus for providing a game in which, for each character, a required value for selection required to select the character and an ability value of the character are set, and a plurality of target characters are selected from a plurality of possessed characters owned by a player and are applied to an event, the game apparatus comprising:
a selector adapted to select the plurality of target characters from the plurality of possessed characters such that the total of the ability values of the plurality of target characters is maximum under the condition that the sum of the required values for selection of the plurality of target characters is equal to or smaller than a permissible value for selection given to the player.

2. The game apparatus according to claim 1, wherein the selector comprises:
an ability value analyzing section adapted to, for each of the plurality of possessed characters, an ability value corresponding to a unit amount of the required value for selection of the possessed character, as a unit ability value;
an index calculation section adapted to calculate, for each of the plurality of possessed characters, an ability index value corresponding to the sum of the ability value of the possessed character and the ability value acquired when the minimum value of the unit ability values is assigned to the remaining value obtained by subtracting the required value for selection of the possessed character from the permissible value for selection given to the player; and
a first selection processor adapted to select possessed characters in descending order of the ability values indicated by the ability index values of the possessed characters, as target characters, under the condition that the sum of the required values for selection of the plurality of target characters is equal to or smaller than the permissible value for selection given to the player.

3. The game apparatus according to claim 2, wherein the first selection processor is adapted to sequentially select possessed characters in descending order of the ability values indicated by the ability index values, and to calculate the accumulated value of the required values for selection of the selected possessed characters, and wherein when the accumulated value has exceeded the permissible value for selection of the player, the first selection processor is adapted to release the selection of the possessed character selected last and to select the next possessed character in order.

4. The game apparatus according to claim 2, wherein the selector further comprises a second selection processor adapted to select, when the sum of the required values for selection of a predetermined number of possessed characters selected in descending order of the ability values is equal to or smaller than the permissible value for selection, the predetermined number of possessed characters as target characters,
wherein the first selection processor adapted to select target characters according to the ability index values when the sum of the required values for selection of the predetermined number of possessed characters has exceeded the permissible value for selection.

5. The game apparatus according to claim 1, wherein the selector adapted to designate a specific character as a target character from the plurality of possessed characters and to select target characters other than the specific character from the plurality of possessed characters such that the sum of the required values for selection of target characters that include the specific character is equal to or smaller than the permissible value for selection of the player.

6. The game apparatus according to claim 1, wherein the ability value includes a first ability value and a second ability value; and
the selector is adapted to select a plurality of target characters to be applied to a first event such that the total of the first ability values is maximum under the condition that the sum of the required values for selection of the plurality of target characters is equal to or smaller than a first permissible value for selection of the player, and to select a plurality of target characters to be applied to a second event such that the total of the second ability values is maximum under the condition that the sum of the required values for selection of the plurality of target characters is equal to or smaller than a second permissible value for selection of the player.

7. A program for causing, in order to provide a game in which, for each character, a required value for selection required to select the character and an ability value of the character are set, and a plurality of target characters are selected from a plurality of possessed characters owned by a player and are applied to an event, a computer to function as a selector adapted to select the plurality of target characters from the plurality of possessed characters such that the total of the ability values of the plurality of target characters is maximum under the condition that the sum of the required values for selection of the plurality of target characters is equal to or smaller than a permissible value for selection given to the player.

8. A game providing method of providing a game in which, for each character, a required value for selection required to select the character and an ability value of the character are set, and a plurality of target characters are selected from a plurality of possessed characters owned by a player and are applied to an event, the game providing method comprising:
selecting the plurality of target characters from the plurality of possessed characters such that the total of the ability values of the plurality of target characters is maximum under the condition that the sum of the required values for selection of the plurality of target characters is equal to or smaller than a permissible value for selection given to the player, in a game apparatus.
